(19) United States
(12) Patent Application Publication
(10) Pub. No.: US 2024/0286623 A1
(43) Pub. Date: Aug. 29, 2024

(54) METHOD FOR SELECTING A RELAXING OR STIMULATING SERVICE FOR A DRIVER OF A MOTOR VEHICLE

(71) Applicants: RENAULT S.A.S, Boulogne Billancourt (FR); NISSAN MOTOR CO., LTD., Kanagawa (JP)

(72) Inventors: Nathalie LE-HIR, Guyancourt cedex (FR); Denis MOZZO, Gyuancourt cedex (FR)

(73) Assignees: RENAULT S.A.S, Boulogne Billancourt (FR); NISSAN MOTOR CO., LTD., Kanagawa (JP)

(21) Appl. No.: 18/570,215

(22) PCT Filed: Jun. 15, 2022
(86) PCT No.: PCT/EP2022/066412

§ 371 Date: Dec. 14, 2023

(30) Foreign Application Priority Data
Jun. 15, 2021 (FR) FR2106317

(51) Int. Cl. B60W 50/00; B60K 28/02

(52) U.S. Cl. CPC B60W 50/0098; B60K 28/02; B60W 2540/22

(57) ABSTRACT

A method selects a service for a driver of a motor vehicle from a list of services intended for the driver. The method enables a selection to be made in accordance with contexts relating to the driver, the vehicle and the external environment so as to optimise driver comfort and safety. The selection of at least one relaxing or stimulating service from a list of services is made according to the physiological state of the driver or according to the requirement of the driver, according to the driver's level of availability, according to the driver's usage preferences and according to data characterising the level of experience of the driver of the vehicle.

The invention relates to a method for selecting a relaxing or stimulating service for a driver of a motor vehicle. The invention also relates to a system for selecting a service and a vehicle equipped with such a system. The invention also relates to a computer program implementing the mentioned method.

In the automotive industry, it is known to equip vehicles with systems offering services that are intended to affect a state or a mood of the driver, in particular relaxing or else stimulating services. Such services may in particular be offered and executed when the vehicle is at a standstill or when the vehicle is moving.

Due to the wide variety of existing services, existing systems may be liable to offer services that are unsuitable for the driver, on the one hand, and/or unsuitable for a particular situation that the driver is in, on the other hand.

The invention falls within this context and aims to provide a method for selecting a service for the attention of the driver that makes it possible to overcome the abovementioned drawbacks at a low cost.

The invention proposes a method for selecting a relaxing or stimulating service for a driver of a motor vehicle equipped with at least one memory unit in which a list of services intended for the driver is stored. The selection method comprises:
a step of detecting a physiological state of the driver or a step of providing information about a need of the driver;
a step of detecting a context external and/or a context internal to the vehicle; and
a step of computing a level of availability of the driver on the basis of the data in relation to the context external and/or to the context internal to the vehicle;
a step of consulting use preferences of the driver; and
a step of consulting data characterizing at least one level of experience that the driver has of using the relaxing or stimulating services; and then
the selection of at least one relaxing or stimulating service from the list of services being carried out on the basis of the physiological state of the driver or on the basis of the need of the driver, on the basis of the level of availability of the driver, on the basis of the use preferences of the driver and on the basis of the data characterizing the level of experience of the driver of the vehicle.

The selection method may comprise a first selection phase of selecting a first subset of services, comprising at least one service, within the list of services, the first selection phase being carried out on the basis of the physiological state of the driver in order to correct the detected state of the driver or the first selection phase being carried out on the basis of a need of the driver in order to address said need. The method may then comprise a second selection phase of selecting a second subset of services, within the first subset, carried out on the basis of the level of availability of the driver, on the basis of the use preferences of the driver and on the basis of the level of experience of the driver.

The selection method may comprise a random selection step, implemented when, at the end of the selection of at least one service on the basis of the physiological state of the driver or on the basis of the need of the driver, and on the basis of the level of availability, of the use preferences and of the level of experience of the driver, a plurality of services are available.

The step of detecting a state of the driver may comprise:
a sub-step of measuring at least one emotional and/or physiological parameter of the driver; and/or
a sub-step of detecting at least one abnormal or risky driving behavior by way of at least one driving assistance system and/or by way of a measuring member fitted in the vehicle; and
a sub-step of classifying the state of the driver on the basis of the physiological parameter of the driver and/or on the basis of the driving behavior of the driver, a service being selected when an abnormal state of the driver is detected.

The step of computing a level of availability of the driver may comprise a sub-step of classifying the level of availability of the driver on the basis of the data in relation to the context external and/or to the context internal to the vehicle.

Furthermore, the selection method may comprise at least one step of providing information about at least one preference of the driver in relation to all or some of the services contained in the list of services, the information provision step being able to be executed prior to the step of detecting a state of the driver or to the step of providing information about a need of the driver, in particular when the vehicle is at a standstill, and/or the information provision step being able to be executed following the selection of a service.

The step of consulting the level of experience of the driver may comprise a step of determining the level of experience of using the services on the basis of a number of occurrences of the driver executing the services and a step of comparing the level of experience with an experience index, specific to each service and defining a minimum level of experience required by the driver to execute the service correctly, the service being selected when the experience index is lower than or equal to the detected level of experience of the driver.

The invention also relates to a method for relaxing or stimulating a driver of a motor vehicle, the method first comprising the steps of the selection method as disclosed above and then a step of executing at least one selected service, implemented when a number of services selected at the end of the selection method is greater than or equal to 1, or a step of interrupting the execution method early, implemented when the number of services selected at the end of the selection method is zero.

The relaxation or stimulation method may comprise a step of blocking a repetition of the steps of the selection method, implemented following a step of executing a service during an execution cycle of the method, so as to prevent the successive execution of services within an interval of a duration less than a predefined threshold value.

The relaxation or stimulation method may comprise, following the execution of a service, a step of saving the level of experience of the driver in relation to said service or a step of modifying a previously stored level of experience of the driver in relation to said service.

The invention also relates to a system for selecting a relaxing or stimulating service for a driver of a motor vehicle, the system comprising hardware and/or software elements implementing the selection method according to the invention, the hardware elements comprising at least one data processing unit configured to cooperate with at least one memory unit in which the list of services intended for the driver is stored.

The invention also relates to a motor vehicle equipped with a selection system as described above and with at least one means for implementing one or more relaxing or stimulating services.

The invention also extends to a computer program product comprising program code instructions, which are stored on a computer-readable medium, for implementing the steps of the selection method and/or for implementing the steps of the relaxation or stimulation method when said program runs on a computer. As an alternative, such a computer program product may be able to be downloaded from a communication network and/or stored on a computer-readable and/or computer-executable data medium, the computer program product comprising instructions that, when said computer program product is executed by the computer, cause said computer to implement the selection method and/or the relaxation or stimulation method.

The invention may also relate to a computer-readable data storage medium on which there is recorded a computer program comprising program code instructions for implementing the selection method and/or the relaxation or stimulation method according to the invention. In other words, such a storage medium comprises instructions that, when they are executed by a computer, cause said computer to implement the selection method and/or the relaxation or stimulation method.

The invention relates lastly to a data medium signal carrying the computer program product as disclosed above.

Other details, features and advantages will become more clearly apparent upon reading the detailed description given below, by way of indication and without limitation, with reference to the various exemplary embodiments illustrated in the following figures:

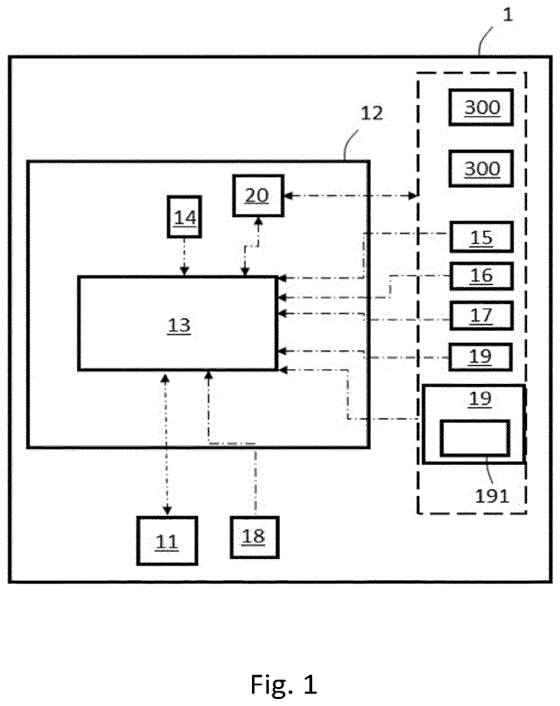

FIG. 1 schematically shows one embodiment of a vehicle equipped with a selection system.

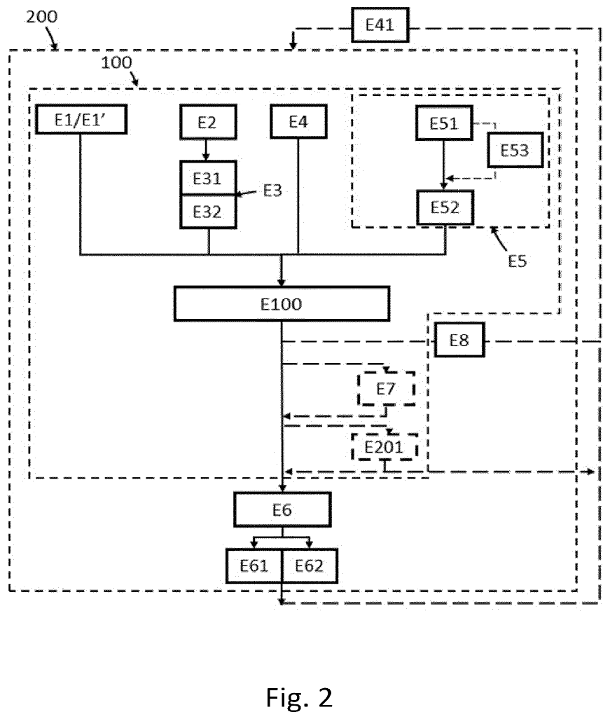

FIG. 2 is a general flowchart of the execution of a selection method.

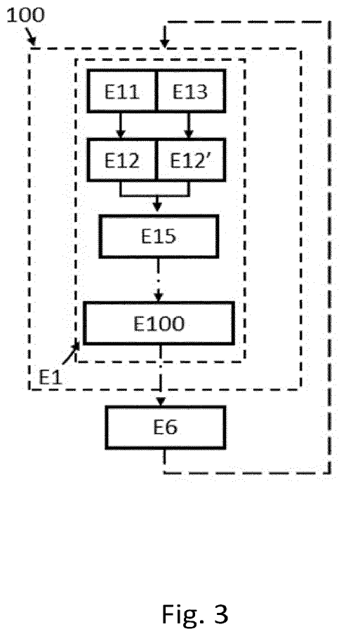

FIG. 3 is a detailed flowchart of one example of the execution of a step of detecting a state of a driver of the selection method.

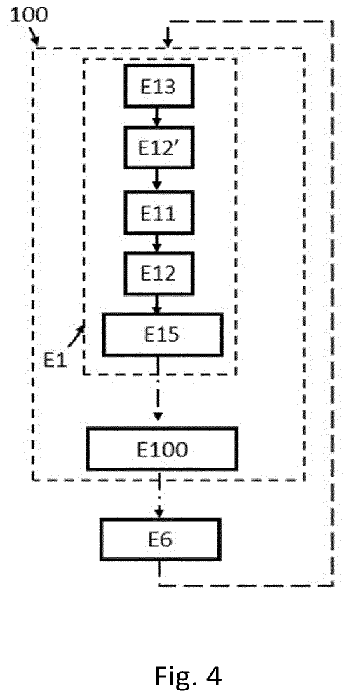

FIG. 4 is a detailed flowchart of one alternative example of the execution of the step of detecting a state of the driver.

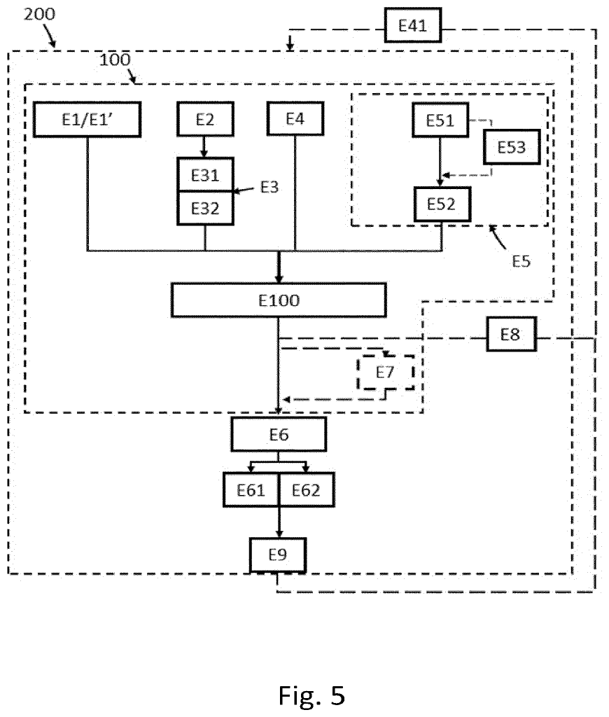

FIG. 5 is a general flowchart of one alternative mode of execution of the selection method.

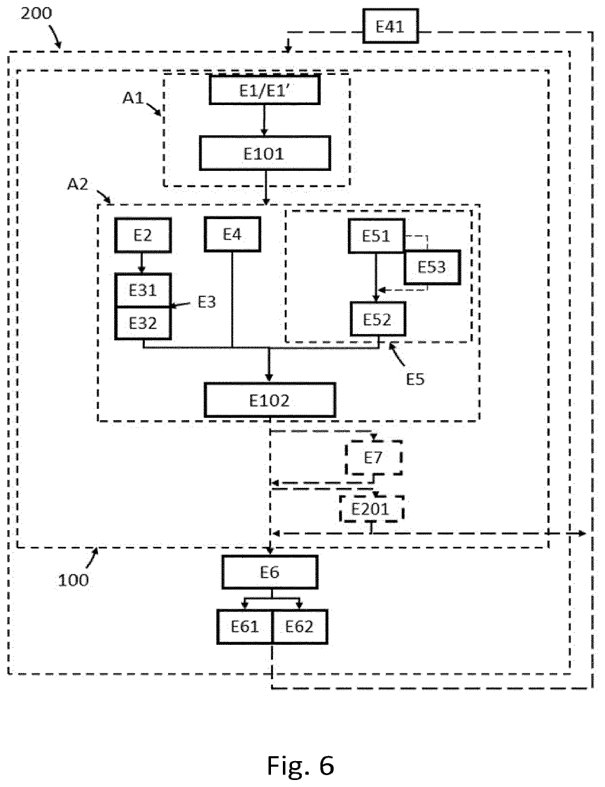

FIG. 6 is a general flowchart of one particular mode of execution of the selection method.

FIG. 1 schematically illustrates a motor vehicle 1 according to one embodiment of the invention. The vehicle 1 may be of any kind. In particular, it may be a private vehicle, a utility vehicle, a truck or a bus. The vehicle may also be an autonomous or non-autonomous vehicle.

The vehicle 1 is equipped in such a way as to offer a driver a variety of services, in particular relaxing or stimulating services. In this sense, the vehicle 1 may be equipped with means 300 for implementing such services, for example an internal lighting system, an air-conditioning system, a heating system, an internal audio system, a system for creating an olfactory ambiance, or a system for creating a luminous and/or tactile ambiance. The vehicle is also equipped with at least one memory unit 11 in which a list of services, in particular relaxing or stimulating services, intended for the driver, is stored. The vehicle 1 furthermore comprises a system 12 for selecting a service for the attention of the driver, comprising hardware and/or software elements able to implement a method 100 for selecting a service as illustrated in FIGS. 2 to 6.

The system 12 comprises in particular at least one data processing unit 13. According to one particular example, the system may comprise the memory unit 11 in which the list of services is stored, or as an alternative, the system may be configured so as to exchange data with the memory unit 11 contained in the vehicle 1. Additionally, the system 12 may comprise at least one memory element 14 that is specific thereto.

The processing unit 13 comprises at least one computing unit comprising hardware and software resources, more specifically at least one processor, or microprocessor, cooperating with the memory unit 11 and/or with the memory element 14. This computing unit is able to execute instructions so as to implement a computer program.

The selection system 12 may furthermore comprise, or be able to exchange data with, various elements of the vehicle, such as:
a locating means 15 for locating the position of the vehicle 1 in a road infrastructure; and/or
a monitoring unit 16 for monitoring a state of the user; and/or
a communication module 17 for communicating with a connected device and/or a database; and/or
one or more measuring members 18 for measuring data in relation to the vehicle 1, in particular the longitudinal speed of the vehicle 1; and/or
one or more driving assistance systems 19.

The locating means 15 makes it possible to locate the vehicle 1 in the road infrastructure. It incorporates for example a locating system for locating the vehicle and/or a map of the road infrastructure. In particular, the location of the vehicle 1 may be provided by a GPS (acronym for “Global Positioning System”) system. As an alternative or in addition, the locating means 15 may be a locating system housed on board the vehicle 1. The location of the vehicle 1 makes it possible to extract, from a map database, information regarding the road infrastructure and/or the topology and/or the geography within a radius of a few hundred meters around the position of the vehicle 1.

The monitoring unit 16 is configured to monitor a physiological state of the driver and to make it possible, without limitation, to detect a state of fatigue, sleepiness or else stress or anxiety of said driver that is liable to affect their behavior while driving. The monitoring unit 16 may comprise at least one monitoring sensor, such as a camera arranged in the passenger compartment of the vehicle 1 or a sensor fitted in an element of the vehicle 1, for example a steering wheel, able to measure at least one physiological parameter of the driver from among in particular gaze direction, head movement, heart rate or electrodermal activity.

The communication module 17 allows the vehicle 1 to receive data from a database, from connected devices, for example from a connected telephone, from a connected remote vehicle or else from a connected urban or road infrastructure element by way of a low-frequency or high-frequency wireless link. This may for example be a wireless link based on “cellular”, “Bluetooth” or “Wi-Fi” technologies (registered trademarks). Such data may, non-exhaustively, relate to the driver, for example ongoing use of a connected device or an event scheduled in a diary, or relate to a context external to the vehicle 1, for example weather conditions, traffic conditions, or topological or geographical conditions.

The one or more measuring members 18 are able to carry out measurements in relation to one or more parameters of the vehicle 1 such as, without limitation, the longitudinal speed, the acceleration and/or the deceleration of the vehicle, the pressure exerted on the brake pedal or the rate of pressure exerted on the brake pedal. As an alternative, all or some of said parameters may be measured by a driving assistance system 19.

As illustrated, the vehicle 1 may be equipped with at least one driving assistance system 19 comprising in particular at least one detection means 191 for detecting the environment of the vehicle 1, such as for example a radar and/or a lidar and/or a camera. By way of non-limiting example, a “driving assistance system” is understood to mean an autonomous emergency braking system, also known as AEB (“Automatic Emergency Braking”) system, a detection system for detecting nearby vehicles and/or a parking assistance system. In particular, the vehicle 1 may comprise a plurality of driving assistance systems 19.

The processing unit 13 of the selection system 12 is thus able to exchange information with the memory unit 11, but is also able to receive data from the locating means 15 and/or from the monitoring unit 16 and/or from the communication module 17 and/or from at least the one or more measuring members 18 and/or from the one or more driving assistance systems 19 as disclosed above, such data then being used in the method as disclosed below in order to make it possible to select a service for the driver. The processing unit 13 may also carry out exchanges with a control unit 20, fitted in the vehicle and possibly for example contained in the selection system 12. Such a control unit 20 may for example be able to act on the various components 11, 14, 15, 16, 17, 18 or 19 mentioned above and/or on the means 300 for implementing one or more relaxing or stimulating services and/or be able to control an operating status thereof, for example executed parameters or settings.

A general flowchart and one particular example of the execution of the selection method 100 are illustrated in FIGS. 2 and 6, respectively. The selection method 100 may also be considered to be a method for operating the selection system 12 according to the invention or to be a method for operating a motor vehicle 1 equipped with such a system. The method is in particular configured in order to implement the selection of at least one relaxing or stimulating service with a view to execution thereof on the basis of a physiological state of the driver, making it possible for example to indirectly detect an emotional state of the driver. In particular, the service selected by the method may then seek to at least partially correct such a state. As an alternative, the method according to the invention may be executed on the basis of a need of the driver, in particular provided thereby. The service is then selected in order to address such a need. The method is also configured in order to implement such a selection on the basis of a level of availability of the driver, use preferences of the driver and data characterizing a level of expertise of the driver of the vehicle and/or a level of experience of using the services. FIGS. 2 and 6 also illustrate a method 200 for relaxing or stimulating the driver, comprising the steps of the selection method 100 according to the invention.

The selection method 100 comprises a step E1 of detecting a state of the driver or a step E1′ of providing information about a need of the driver.

When the method comprises the step E1 of detecting a physiological state of the driver, it makes it possible in particular to detect and distinguish between a normal or balanced state of the driver and an abnormal state. In particular, the method may be executed conditionally such that it continues only when an abnormal or unbalanced state of the driver is detected. The method then seeks to correct such a detected abnormal state in order to return the driver toward or to a normal or balanced state. In other words, the method seeks to address a need of the driver as identified by the vehicle 1. As an alternative, when a normal or balanced state is detected, the one or more services may be selected according to whether they make it possible to maintain such a state.

By way of non-limiting example, an abnormal state of the driver may relate to a state of stress or anxiety, that is to say a state in which the driver is overstimulated and requires a relaxing service, or to a state of fatigue, sleepiness or boredom, that is to say an understimulated state in which they require a stimulating or revitalizing service.

As detailed in FIG. 3, the detection step E1 may comprise a sub-step E11 of directly measuring at least one physiological parameter of the driver. For example, the monitoring unit 16 may measure the gaze direction, the head movement, the heart rate or the electrodermal activity of the driver, such parameters making it possible, inter alia, to detect agitation, which is in particular representative of a state of stress or anxiety of the driver, and then transmits these measurements to the processing unit 13. The selection system 12 then executes a sub-step E12 of classifying the state of the driver on the basis of the physiological criterion of the driver. In other words, the processing unit 13 is able to carry out computing and comparison operations that are able to determine whether the one or more measured criteria, by way of an upper or lower value, cross at least one given reference threshold, thus making it possible where applicable to identify a state of the driver from among the various states mentioned above.

As an alternative or in combination with the measuring step E11, a physiological state of the driver may be detected indirectly by analyzing their driving. The method may then comprise a sub-step E13 of detecting at least one abnormal or risky driving behavior, executed by way of the one or more driving assistance systems 19 and/or by way of the one or more measuring members 18 of the vehicle 1. At least one emotional and/or physiological parameter of the driver may then be defined indirectly by the driving of the driver. For example, the triggering, on at least one occasion or repeatedly, of an event initiated by the one or more driving assistance systems 19 aimed at preventing a risky situation, such as braking implemented by an AEB system, may be characteristic of a state in which the driver is falling asleep. According to another example, the detection of an abnormally irregular longitudinal speed by the one or more measuring members may be defined as being characteristic of a state of stress of the driver.

Optionally, such a detection E13 may also take into consideration an environment external to the vehicle 1, for example weather conditions or a geolocation, provided in particular by the locating means 15.

The method then comprises a step E12′ of classifying the state of the driver, which is similar to the classification step E12 disclosed above, with the difference that, this time, it is executed on the basis of the driving behavior of the driver as detected by way of the one or more driving assistance systems and/or of the one or more measuring members 18 fitted in the vehicle 1.

According to the exemplary embodiment illustrated in FIG. 3, when the detection step comprises a sub-step E11 of measuring at least one emotional and/or physiological criterion of the driver and a detection sub-step E13, said sub-steps may be executed at least partially at the same time as one another. The method may then in particular continue as soon as an abnormal state is identified from the sequences of sub-step E11 and/or sub-step E13.

As an alternative, as illustrated in FIG. 4, one of said sub-steps E11, E13 may be executed in such a way as to confirm a state detected in the other of said sub-steps. For example, the driving assistance system 19 may detect a state of sleepiness of the driver due to the repeated triggering of emergency braking, and then the monitoring unit 16 may confirm such a state on the basis of a measurement of the heart rate or a frequency of the drooping of the eyelids of the driver. In other words, sub-steps E11, E13 are then executed in succession with one another. The inverse operation may also be implemented, that is to say that the driving assistance system 19 and/or one or more measuring members make it possible to confirm a state of the driver as detected by the monitoring unit 16.

A service is selected on the basis of a state in particular in such a way as to correct the detected state of the driver, that is to say that such a service aims to return the driver toward or to a balanced state. Each service is thus characterized by data in relation to an identifier and to at least one state index and/or need index, corresponding to the detected state for which it is intended and/or a need that it addresses. For example, some breathing or yoga exercise services are intended for a driver exhibiting a state of overstimulation, that is to say a state of stress or anxiety, and address a need to relax. The method thus comprises, following the execution of sub-step E11 and/or sub-step E13, a sub-step E15 of comparing the detected state of the driver with the state index and/or need index specific to each service in order to make it possible to select a service suited to a physiological state of the driver at a given time.

The system also executes a step E2 of detecting a context external and/or a context internal to the vehicle. Such data may then be used by the selection system 12 in order to define the level of availability of the driver. In other words, the method then comprises a step E3 of computing a level of availability of the driver on the basis of the data in relation to the context external and/or to the context internal to the vehicle. According to the mode of execution of the method illustrated in FIGS. 2 to 5, all or part of step E2 and/or of step E3 may be executed at the same time as step E1, as disclosed above.

A level of “availability” is understood to mean a parameter aimed at defining a degree to which the driver is able to be called upon or a degree of attention of the driver that may be required when executing the service. Such a parameter aims in particular to adapt the service to be executed in such a way as not to call upon or interrupt the driver at an inopportune time, or even in a risky situation or a situation liable to generate a risk.

The step E3 of computing the level of availability of the driver comprises, similarly to what was disclosed above in relation to the state of the driver, a sub-step E31 of classifying the availability of the driver into various levels. By way of non-limiting example, the availability of the driver may be classified according to at least three levels:
a level of total availability, for which an implemented service may for example call upon the driver without any risk or without generating any inconvenience, in particular by invoking all or some of their attention;
a level of total unavailability, for which the executed service should be discreet and should not call upon or invoke the driver;
at least one intermediate level of availability, between the level of total availability and the level of total unavailability, for which the attention of the driver may be partially invoked.

The data in relation to the internal context of the vehicle may in particular concern a status of the vehicle 1, that is to say in particular whether the vehicle is at a standstill, in a driving phase or else whether a technical incident has been detected. These data are for example transmitted to the processing unit 13 of the selection system 12 by the one or more measuring members 18 fitted in the vehicle and may concern a status of at least one motor of vehicle 1, of the parking brake, a longitudinal speed of the vehicle or a regularity of such a speed. These data may also be communicated by the one or more driving assistance systems 19, for example in order to inform the selection system 12 about a fluidity of the driving, a number of overtaking maneuvers carried out, or any other value likely to be relevant. Thus, when the vehicle 1 is at a standstill, or if the vehicle 1 is moving at a low longitudinal speed, for example less than 15 km/h, the selection system may deduce, following its computation, a state of total availability of the driver. On the contrary, if the vehicle 1 is in motion and has a high longitudinal speed, the driver may be considered to have intermediate availability or to be unavailable.

The context internal to the vehicle may also concern the use of a connected device, for example a telephone, or else the use of systems housed on board the vehicle, for example a multimedia system, not shown. In other words, the selection system 12 may also be configured in order to take into consideration at least one connected device, in particular how this is being used. For example, if a call is ongoing, the driver will be considered to be unavailable.

As an alternative or in addition, the level of availability of the driver may be defined on the basis of data in relation to the context external to the vehicle 1, that is to say for example data in relation to the weather conditions, topological conditions, geographical conditions or else in relation to the traffic. For example, these data may be transmitted by at least one out of the one or more driving assistance systems 19, the one or more measuring members, the locating means 15 or a connected device. Congested traffic, poor weather conditions, mountainous or hazardous roads may for example be characteristics of the “unavailable” level or of a level of “intermediate availability”.

The step E31 of classifying the level of availability of the driver may be carried out in such a way as to simultaneously take into account all of the received data in relation to the availability of the driver in order to define their level of availability directly. As an alternative, the selection system 12 may associate a level of availability of the driver with each type of data beforehand, and then, on the basis thereof, compute a general level of availability. In particular, the system may be configured so that, if at least one type of data, for example the use of a connected device, indicates a state of unavailability of the driver, the general level of availability of the driver will be qualified as “unavailable”.

Thus, according to some non-limiting examples, if the driver is currently having a telephone conversation, they are considered to be unavailable, even if they are traveling on a freeway with a small amount of traffic or if they are at a standstill. It is then necessary to select, from among the services of the first subset, a service that is discreet, or even imperceptible, which does not require any contribution from the driver. For example, such a service may comprise adjusting the temperature in the passenger compartment or else the brightness therein, without requiring any adjustment or intervention from the driver. On the contrary, when the vehicle 1 is at a standstill, in particular in a parking area, and the driver is deemed to be available, for example at the end of a journey, a service that engages them to a great extent may be chosen from among the services contained in the first subset, for example breathing or yoga exercises, with eyes open or even closed.

Following the sub-step E31, the method comprises a sub-step E32 of comparing the computed level of availability of the driver with an availability index, specific to each service, defining a level of availability of the driver needed for the service to be able to be executed. In other words, the service is selected if it has an availability index lower than or equal to the computed level of availability of the driver.

The method also comprises a step E4 of consulting use preferences of the driver, in particular preferences saved in the memory unit 11 contained in the vehicle or in the selection system 12. As an alternative, such preferences may be saved in the memory element 14 of the selection system 12. The “preference” criterion is defined on the basis of the tastes and/or choices of the driver. In this sense, the method may comprise at least one step E41 of providing information about at least one preference of the driver in relation to all or some of the services contained in the list of services. Such a step may be executed prior to the consultation step E4, for example when the vehicle 1 is at a standstill or when adjusting the selection system 12 of the vehicle 1. As an alternative, the information provision step E41 may be executed at the end of an execution cycle of the selection method 100, that is to say for example after a selected service has been implemented. According to one alternative, not shown, the method may comprise a plurality of steps of providing information about a preference, such that one is executed at the start of the method, while the other is executed at the end thereof.

The information provision step E41 may thus comprise a sub-step of entering a preference, for example defined by a system for grading or assessing the service, and also a sub-step of saving such a preference or a sub-step of modifying previously stored data in relation to said preference. The preference may be entered through a manual input, for example by way of a specific menu presented on a human-machine interface fitted in the vehicle 1. The driver may then select, deselect or else grade the services. According to another exemplary embodiment, such a preference may have been detected by the vehicle 1 in a previous execution cycle of the method. For example, a service may be considered to be preferred if the user allows it to be executed in its entirety or if at least one physiological criterion of the driver as disclosed above indicates that the driver likes the service. On the contrary, a service may be considered to be undesirable if the driver interrupts it manually, by way of the human-machine interface in particular, or if such a service appears to take the driver further away from a normal or balanced state, for example if said service generates stress or additional annoyance for the driver.

The level of “expertise” of the driver relates in particular to a level of experience of the driver in terms of implementing the various services contained in the list, that is to say their ability to use said services and their familiarity with regard to said services. Indeed, it is preferable for the driver, if they are required to contribute during the execution of the service, to be able to execute this without difficulty, or at least without excessive difficulties, in particular if the service is executed during a driving phase and it is essential not to unduly distract the attention of the driver.

The method thus comprises a step E5 of consulting data characterizing the level of expertise of the driver, this being defined at least on the basis of the level of experience that the driver has of using the services. In other words, the method comprises a step E5 of consulting data characterizing the level of expertise of the driver and/or the level of experience that the driver has of using the services. The level of experience of the driver may, according to one exemplary embodiment, at least be defined by way of a sub-step E51 of determining the level of experience of using the services on the basis of a number of occurrences of the driver executing the services. For example, the selection system 12 may comprise a counter configured to increase a number of occurrences of execution of a service under consideration as soon as said service is implemented, in particular in its entirety, by the driver. Various levels of experience of the driver may then be defined on the basis of threshold values of the number of occurrences of execution of a service under consideration.

By way of example, the level of experience of the driver may be defined according to whether the driver is a “beginner”, “well-versed” or an “expert” in the use of a service under consideration. Indeed, in order not to disturb the driver, and therefore not to generate a risky situation, it may be preferable to limit or even block access to certain services, in particular when such services involve invoking the attention of the driver to a greater extent. According to one non-limiting example, a driver may be considered to be a beginner for a service under consideration if they have executed it fewer than three times, to be well-versed when they have executed it between three and five times and to be an expert when they have executed it more than five times.

Such a sub-step E51 is followed by a sub-step E52 of comparing the level of experience of the driver with an experience index specific to each of said services, such an index defining a minimum level of experience required by the driver to execute the service correctly. For example, a breathing exercise having an “expert” experience index may be made inaccessible to a beginner driver and be made available only after the execution of similar services whose experience index is lower. In other words, a service is selected when it has an experience index lower than or equal to the detected experience level of the driver.

In addition or as an alternative, each service may have various difficulty settings, each of said settings being defined by an expertise index that is specific thereto. The “expert” setting of a service, for example of the breathing exercise mentioned above, may then be made inaccessible to a driver who has not executed the “beginner” and/or “well-versed” settings beforehand. The selection system 12 may then, as disclosed above, count the occurrences of execution of each setting and make accessibility to a service with a defined setting subject to the execution of a predefined number of occurrences of the lower-level settings.

According to one particular exemplary embodiment, illustrated in dashed lines in FIG. 2, the experience index specific to a service may also be adjusted by the processing unit on the basis of the data in relation to the physiological state of the driver and/or on the basis of the data in relation to the context external and/or to the context internal to the vehicle, as disclosed above. The experience index of the breathing exercise with the “expert” level cited above may thereby be modified on the basis of said data. For example, the experience index may be lowered when the status of the vehicle 1 indicates that it is at a standstill, such that the service is then made accessible to a driver having a “beginner” level of experience with regard to this service. The method may then comprise a sub-step E53 of adjusting the experience index specific to at least one service, for example executed prior to step E1 or to step E52.

Optionally, during the execution of the step E21 of consulting the expertise of the driver, the selection system 12 may also take into account a driving level of the driver, corresponding in particular to an age of the driving license of the driver, provided by said driver beforehand. For example, a driver having a driving license the age of which is greater than three years may be classified as being an experienced driver. On the contrary, a driver whose driving license has an age less than three years may be considered to be a young driver or a novice driver.

Thus, the selection E100 of at least one relaxing or stimulating service from the list stored in the memory unit 11 and/or the memory element 14 on the basis of the physiological state or of a need of the driver, of their level of availability, of their use preferences and of their level of expertise, has the result of obtaining a subset of services having a number of services strictly less than the number of services contained in the initial list. The subset thus advantageously comprises one or more services suited to the context in relation to the driver, to the internal context of the vehicle and to the context external to the vehicle 1.

Following the execution of the selection method 100, as illustrated in FIG. 2 or 5, the vehicle may, as part of the relaxation or stimulation method 200 as cited above, implement a step E6 of executing a selected service. The execution step E6 is implemented in particular when the number of selected services contained in the subset of services at the end of the selection method is greater than or equal to 1. If the subset comprises a single service, the vehicle 1 then implements this execution step E6 directly.

Optionally, when the subset comprises a plurality of services, the selection method 100 furthermore comprises a random selection step E7, shown here in dashed lines, so as to select only a single service to be executed. Such a selection is implemented in particular by the processing unit 13. The vehicle 1 may then execute the selected service as disclosed above.

Optionally, once a single service has been selected from the list of services, that is to say following the selection E100 or following the selection E7, the method may comprise a step E201 of checking a status of at least one means 300 for implementing the selected service. The control unit 20 and/or the processing unit 13 may then detect data in relation to the status, in real time, of the at least one means 300, that is to say detect for example whether or not it is currently operating or else detect executed parameters and settings if the means 300 is currently being used. The control unit 20 may then compare the data in relation to the detected status of the at least one means 300 with data stored in the memory unit 11 and/or the storage memory 14 in relation to a status to be executed, corresponding in particular to parameters or settings to be implemented in order to allow the execution of the selected service. When the control unit 20 and/or the processing unit 13 detect/detects that these data are identical, that is to say that the selected service is already being executed, for example due to a previous execution cycle of the relaxation or stimulation method, the selection method may then be repeated immediately or subsequently. When such data differ, that is to say the selected service is not currently being executed, the vehicle 1 may then execute said service. For example, for a relaxing service requiring the luminous ambience creation system to implement lighting in cold tones, if the control unit 20 and/or the processing unit 13 detect/detects that said system is already currently being used with these same parameters or settings, then the method may be repeated, in particular in order to make it possible to select a new service within the list of services.

As illustrated in FIGS. 2 and 5, if the subset is empty, that is to say if it comprises a number zero of services, a step E8 of interrupting the relaxation or stimulation method early may then be executed. The method may then be repeated, immediately or subsequently.

The system 12 then executes, following the execution E6 of a service, a step E61 of saving the level of experience of the user in relation to said service or a step E62 of modifying the previously stored level of experience of the user in relation to said service. The level of experience of the driver is thus updated after each execution cycle of the relaxation or stimulation method and the future selection of a service, made during a subsequent execution of the selection method 100, may be optimized.

According to one option, not shown, the system, in particular the control unit 20 and/or the processing unit 13, may implement a step of checking the correct execution of the selected service. Such a step is implemented in accordance with a principle similar to that from step E201. The method may then be configured such that it is repeated when an anomaly is detected in the execution of the service, that is to say when detected data in relation to the status of at least one means 300 for implementing the service differ from stored data, in particular in relation to the status, the parameters or settings that should be observed when the service is executed correctly.

According to one alternative mode of execution of the selection method, the selection method 100 may comprise, as mentioned above, a step E1′ of providing information about a need of the driver rather than a step E1 of detecting a physiological state of the driver. Such an execution alternative is substantially identical to the mode of execution detailed above, and therefore the above applies, description mutatis mutandis, to this alternative. The driver may provide information about a need, manually or vocally, by way of the human-machine interface for example. Such a step E1′ may then trigger the implementation of the method according to the invention.

According to one execution option, illustrated in FIG. 5, the selection system 12 may be programmed such that it prevents the execution of a plurality of services, each specific to a distinct execution cycle of the relaxation or stimulation method 200, within a predefined time interval. In other words, following a step E6 of executing a service implemented in an execution cycle nₓ of the relaxation or stimulation method 200, the selection system 12 may be configured in order to implement a step E9 of blocking the execution of the steps of the selection method 100 in an execution cycle nₓ₊₁ when a duration that has elapsed since the last execution step E6 of the execution cycle nₓ of the method is less than a duration threshold value, for example less than 15 minutes. In other words, the selection system 12 may be configured to count a duration that has elapsed since the implementation of a previous execution step E6.

FIG. 6 illustrates one particular example of the execution of the selection method according to the invention, similar to what has been described above, and therefore the description and the various modes and alternatives above apply, mutatis mutandis. This example of an execution differs from the previous one in that it comprises two distinct phases, in succession with one another, of selecting a service.

In particular, the method comprises a first selection phase A1 of selecting a first subset of services, comprising at least one service, within the list of services, the first selection phase A1 making it possible to select E101 at least one service on the basis of the physiological state of the driver or the first selection phase being carried out on the basis of a need of the driver in order to address said need. In other words, in the first selection phase A1, the step E1 of detecting a physiological state of the driver or the step E1′ of providing information about a need of the driver is executed. In particular, the method may be initiated by detecting a state of the driver by way of the vehicle.

The system 12, in particular the processing unit 13, implements a first selection phase of selecting, within the list of services, the first subset of services. The first subset comprises at least one service. Similarly to what has been disclosed above, when the method comprises the step E1 of detecting a state of the driver, the one or more services selected and integrated into the first subset of services seek to correct the detected state of the driver, that is to say that it seeks to return the driver toward or to a balanced state.

Optionally, the method may be programmed such that it is executed when an abnormal state, that is to say unbalanced state, of the driver is detected. In such a case, the selection E101 and then the second selection phase A2 may be implemented when an abnormal state of the driver is detected in step E1. In other words, the method may be configured such that it stops following the detection step E1 when a normal or balanced state of the driver is detected. As an alternative, when a normal or balanced state is detected, the one or more services integrated into the one or more first subsets may be selected according to whether they make it possible to maintain such a state.

The method then comprises a second selection phase A2 of selecting a second subset of services within the first subset. The second selection phase A2 allows a selection E102 carried out on the basis of the level of availability of the driver, of their use preferences and on the basis of their level of expertise, as disclosed above. The second selection phase A2 then comprises all or some of the various steps and sub-steps in relation to the level of availability, to the preferences and to the level of expertise of the driver. In particular, the second selection phase A2 may comprise at least:
the step E3 of computing a level of availability of the driver on the basis of the data in relation to the context external and/or to the context internal to the vehicle;
the step E4 of consulting use preferences of the driver;
the step E5 of consulting data characterizing a level of experience of the driver, at least defined on the basis of a level of experience that the driver has of using the services.

Optionally, the second phase may comprise the step E2 of detecting the context external and/or the context internal to the vehicle, as disclosed above.

Such a mode advantageously makes it possible to optimize the resources of the vehicle in such a way that the selection system 12, if it is programmed accordingly, executes the second selection phase A2 only when the situation requires this.

Once the second selection phase A2 has been executed, the system thus obtains a second subset of services, resulting from the first subset and therefore from the initial list of services, suited to the context in relation to the driver, to the context of the vehicle 1 and to the context external to the vehicle 1. Optionally, when the subset comprises a plurality of services, the method may comprise the random selection step E7 as described above, corresponding here to a third selection phase. Also, the method may optionally comprise the checking step E201 as disclosed above. The vehicle 1 may then execute the selected service as disclosed above.

The present invention thus proposes a method for selecting a service for the attention of a driver of a motor vehicle from among a list of a plurality of services intended for the driver, the method allowing a selection suited to contexts in relation to the driver, to the vehicle and to the external environment so as to optimize the comfort and the safety of the driver at a low cost, in particular by implementing equipment that is already integrated in the vehicle.

The present invention is not however limited to the means and configurations described and illustrated here, and also extends to any equivalent means or configuration and to any technically feasible combination of such means provided that they ultimately perform the functionalities described and illustrated in this document.

1-10. (canceled)

11. A method for selecting a relaxing or stimulating service for a driver of a motor vehicle equipped with at least one memory unit in which a list of services configured for the driver is stored, the method comprising:
detecting a physiological state of the driver by way of a monitoring unit of the vehicle or a step of providing information about a need of the driver by way of a human-machine interface of the vehicle;
detecting a context external and/or a context internal to the vehicle by way of at least one out of one or more driving assistance systems, one or more measuring members, a locating means of the vehicle or a connected device;
computing a level of availability of the driver based on data in relation to the context external and/or to the context internal to the vehicle;
consulting use preferences of the driver that are saved in a memory unit of the vehicle;
consulting data characterizing at least one level of experience that the driver has of using the relaxing or stimulating services; and then
selecting at least one relaxing or stimulating service from the list of services being carried out based on the physiological state of the driver or based on the need of the driver, based on the level of availability of driver, based on the use preferences of the driver, and based on the data characterizing the level of experience of the driver of the vehicle.

12. The selection method as claimed in claim 11, further comprising:
a first selection phase of selecting a first subset of services, comprising at least one service, within the list of services, the first selection phase being carried out based on the physiological state of the driver in order to correct the detected state of the driver or the first selection phase being carried out based on the need of the driver in order to address said need, and then
a second selection phase of selecting a second subset of services, within the first subset, carried out based on the level of availability of the driver, based on the use preferences of the driver and based on the level of experience of the driver.

13. The selection method as claimed in claim 11, further comprising a random selection step, implemented when a plurality of services are available at the end of the selection of at least one service based on:
the physiological state of the driver or the need of the driver,
the level of availability,
the use preferences, and
the level of experience of the driver.

14. The selection method as claimed in claim 11, wherein the detecting the state of the driver comprises:
measuring at least one emotional and/or physiological parameter of the driver; and/or
detecting at least one abnormal or risky driving behavior by way of at least one driving assistance system and/or by way of a measuring member fitted in the vehicle; and
classifying the state of the driver based on the physiological parameter of the driver and/or based on the driving behavior of the driver, a service being selected when an abnormal state of the driver is detected.

15. The selection method as claimed in claim 11, wherein the consulting the level of experience of the driver comprises determining the level of experience of using the services based on a number of occurrences of the driver executing the services, and comparing the level of experience with an experience index, specific to each service and defining a minimum level of experience required by the driver to execute the service correctly, the service being selected when the experience index is lower than or equal to the detected level of experience of the driver.

16. A method for relaxing or stimulating a driver of a motor vehicle, the method comprising:
the selection method as claimed in claim 11, and then
executing at least one service selected by at least one means for implementing said service, the executing being implemented when a number of services selected at the end of the selection method is greater than or equal to 1, and
interrupting the executing early when the number of services selected at the end of the selection method is zero.

17. The relaxing or stimulating method as claimed in claim 16, further comprising blocking a repetition of the steps of the selection method, implemented following the executing the at least one service in an execution cycle of the selection method so as to prevent the successive execution of services within an interval of a duration less than a predefined threshold value.

18. The relaxation or stimulation method as claimed in claim 16, further, following the executing the at least one service, saving the level of experience of the driver in relation to said service or modifying a previously stored level of experience of the driver in relation to said service.

19. A system for selecting a relaxing or stimulating service for a driver of a motor vehicle, the system comprising:
hardware and/or software elements configured to implement the selection method as claimed in claim 11, the hardware elements comprising at least one data processing unit configured to cooperate with at least one memory unit in which the list of services configured for the driver is stored.

20. A motor vehicle comprising the selection system as claimed in claim 19 and at least one means for implementing one or more relaxing or stimulating services.
